(19) United States
(12) Patent Application Publication
(10) Pub. No.: US 2026/0086496 A1
(43) Pub. Date: Mar. 26, 2026

(54) IMAGE FORMING APPARATUS

(71) Applicant: FUJIFILM Business Innovation Corp., Tokyo (JP)

(72) Inventors: Yasuhisa FUKUDA, Kanagawa (JP); Yuya Chonabayashi, Kanagawa (JP); Yasunobu Goto, Kanagawa (JP); Satoshi Watanabe, Kanagawa (JP); Suguru Goto, Kanagawa (JP); Yuki Kohno, Kanagawa (JP); Yoshinori Kodakari, Kanagawa (JP); Yuki Kawazoe, Kanagawa (JP)

(73) Assignee: FUJIFILM Business Innovation Corp., Tokyo (JP)

(21) Appl. No.: 19/038,179

(22) Filed: Jan. 27, 2025

(30) Foreign Application Priority Data
Sep. 24, 2024 (JP) 2024-165569

(51) Int. Cl. G03G 21/16

(52) U.S. Cl. CPC G03G 21/1647; G03G 21/1638; G03G 2221/1654

(57) ABSTRACT

An image forming apparatus includes an apparatus body in which image formation is performed, an opening and closing member that is openable and closable with respect to the apparatus body, a first locking portion that is provided on one side of the opening and closing member and that locks the opening and closing member while sliding with respect to a locking target portion on one side of an apparatus body side, and a second locking portion that is provided on the other side of the opening and closing member and that locks the opening and closing member via a locking target portion on the other side of the apparatus body side in a state where there is a sliding resistance smaller than a sliding resistance generated in a case where the first locking portion slides with respect to the locking target portion on the one side or a state where there is no sliding resistance.

### CROSS-REFERENCE TO RELATED APPLICATIONS

This application is based on and claims priority under 35 USC 119 from Japanese Patent Application No. 2024-165569 filed Sep. 24, 2024.

### BACKGROUND

### (i) Technical Field

The present invention relates to an image forming apparatus.

### (ii) Related Art

Described in JP2016-194674A is adopting a toggle mechanism, in which a locking member can automatically lock/unlock a locking target portion as a cover is operated to be opened and closed. In addition, a problem described in JP2016-194674A is that engagement backlash is rapidly eliminated before and after the locking member passes through a neutral point of the toggle mechanism and an abnormal noise is generated due to collision between a locking portion and the locking target portion. Therefore, in order to address such a problem, a configuration in which a locking target member is pressed and clamped by the locking member at a time before arrival at the neutral point of the toggle mechanism is described in JP2016-194674A.

### SUMMARY

Examples of a cover that is disposed on, for example, a left side of an image forming apparatus as an opening and closing member that is opened and closed with respect to the apparatus include a cover of which a handle for an opening and closing operation is provided with a locking portion on a front side, which is a front side of the apparatus, and a locking portion on a rear side, which is a rear side of the apparatus. Here, in a case where the cover is deformed to be twisted on the front side and the rear side in such a configuration, a state where the rear side is not locked occurs.

Aspects of non-limiting embodiments of the present disclosure relate to an image forming apparatus that make it easy for an opening and closing member, which can be opened and closed with respect to an apparatus body, to enter a closed state even in a case where one locking member starts to be locked first in a configuration in which the closed state of the opening and closing member is maintained by two or more locking portions.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including an apparatus body in which image formation is performed, an opening and closing member that is openable and closable with respect to the apparatus body, a first locking portion that is provided on one side of the opening and closing member and that locks the opening and closing member while sliding with respect to a locking target portion on one side of an apparatus body side, and a second locking portion that is provided on the other side of the opening and closing member and that locks the opening and closing member via a locking target portion on the other side of the apparatus body side in a state where there is a sliding resistance smaller than a sliding resistance generated in a case where the first locking portion slides with respect to the locking target portion on the one side or a state where there is no sliding resistance.

### BRIEF DESCRIPTION OF THE DRAWINGS

Exemplary embodiment(s) of the present invention will be described in detail based on the following figures, wherein:

FIG. 1 is a view showing a configuration of an image forming apparatus to which the present exemplary embodiment is applied;

FIG. 2 is a view for description about a positional relationship between a handle, a first locking portion, and a second locking portion;

FIG. 3 is a view for description about the first locking portion and the second locking portion;

FIGS. 4A and 4B are views for description about a configuration related to a housing and a closing operation of a cover;

FIGS. 5A and 5B are views showing a state where an inclined surface of the first locking portion is in contact with an inclined surface of a first locking target portion;

FIGS. 6A and 6B are views showing a state where a bottom surface of the first locking portion is in contact with an upper surface of the first locking target portion; and

FIGS. 7A and 7B are views showing a state where the first locking portion and the second locking portion are locked.

### DETAILED DESCRIPTION

Hereinafter, an exemplary embodiment of the present invention will be described in detail with reference to the accompanying drawings.

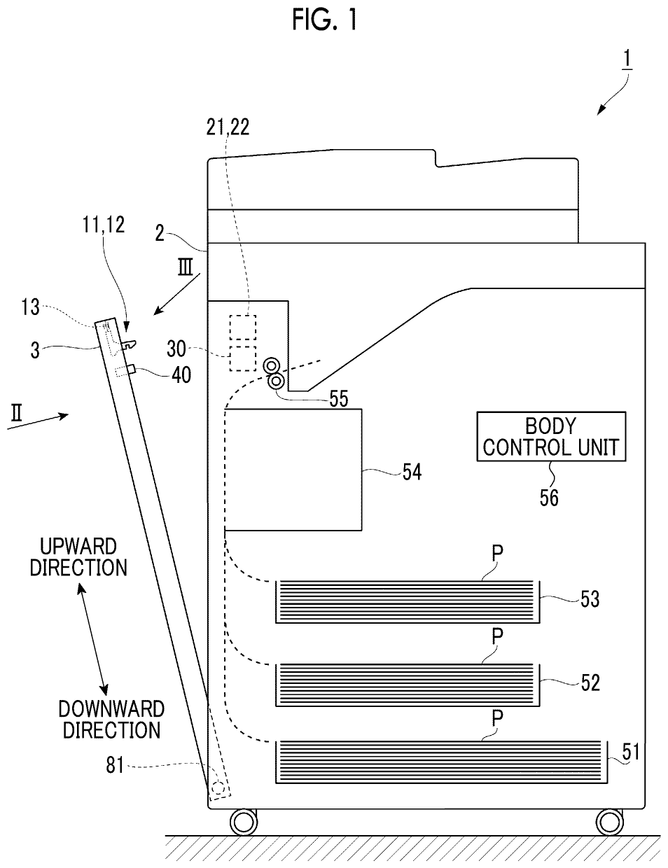

FIG. 1 is a view showing a configuration of an image forming apparatus 1 to which the present exemplary embodiment is applied.

The image forming apparatus 1 forms an image on a recording medium, such as a sheet P, by using an electrophotographic method or the like.

The image forming apparatus 1 includes a housing 2 that is an exterior covering an outer surface of the image forming apparatus 1 and a cover 3 that is openable and closable with respect to the housing 2. The housing 2 and the cover 3 are connected to each other via a cover rotation shaft 81 that rotatably connects the housing 2 and the cover 3 to each other. The housing 2 is an example of an apparatus body and the cover 3 is an example of an opening and closing member.

The image forming apparatus 1 includes various devices for image formation on the sheet P, the devices being provided in the housing 2. The image forming apparatus 1 includes, as major components, sheet accommodation units 51, 52, and 53 that accommodate the sheets P, an image forming unit 54 that forms an image on the sheet P, a discharge roll 55 that discharges the sheet P on which an image has been formed, and a body control unit 56 that controls the operation of the image forming apparatus 1.

The image forming unit 54 forms an image on the sheet P that is transported from each of the sheet accommodation units 51, 52, and 53. For the image forming unit 54, for example, an electrophotographic method of transferring toner adhering to a photoreceptor to the sheet P to form an image is adopted.

The housing 2 includes a first locking target portion 21 and a second locking target portion 22 that lock the cover 3 in a case where the cover 3 is closed. The first locking target portion 21 is provided on a front side of the image forming apparatus 1 and the second locking target portion 22 is provided on a rear side of the image forming apparatus 1. In addition, a toggle mechanism 30, which is an example of an assistance mechanism that assists in a closing operation in a case where the cover 3 is closed, is provided on the rear side of the image forming apparatus 1. Here, the “front side” is, for example, a side on which an operation panel that a user uses to operate the image forming apparatus 1 and is a front surface side in a case where the user operates the image forming apparatus 1. In addition, the front side is an operation side in the case of replacement of a toner cartridge or the like accommodated in the housing 2. Furthermore, the “rear side” is a side opposite to the front side and is a rear surface side in a case where the user operates the image forming apparatus 1. Note that the front side is an example of one side and the rear side is an example of the other side.

For example, in a case where work inside the apparatus is to be performed, such as a case where the sheet P causes a paper jam on a transport path in the image forming apparatus 1 and a user opens and closes the cover 3 to deal with this paper jam, the cover 3 is opened and closed. In the present exemplary embodiment, the cover 3 is provided at a left surface as seen from the front surface side. The cover 3 includes a first locking portion 11 that protrudes toward the housing 2 side and that engages with the first locking target portion 21. In addition, the cover 3 includes a second locking portion 12 that protrudes toward the housing 2 side and that engages with the second locking target portion 22. The first locking portion 11 is provided on the front side of the image forming apparatus 1 and the second locking portion 12 is provided on the rear side of the image forming apparatus 1. Furthermore, the cover 3 includes a suspending spring 13 that suspends the first locking portion 11 and the second locking portion 12 from an upward direction to a downward direction of the cover 3. The upward direction is a direction along a rear surface of the cover 3 and is a direction away from the cover rotation shaft 81. The downward direction is a direction along the rear surface of the cover 3 and is a direction toward the cover rotation shaft 81.

In addition, the cover 3 includes a toggle action member 40 that is formed to protrude toward the housing 2 side and that acts on the toggle mechanism 30. In a case where the cover 3 is closed, the toggle action member 40 presses the toggle mechanism 30 and then is drawn into the toggle mechanism 30.

A direction II shown in FIG. 1 is a direction in which the cover 3 is seen from a surface, and a direction III is a direction in which the cover 3 is seen from the housing 2 side, which is an inner portion side of the image forming apparatus 1.

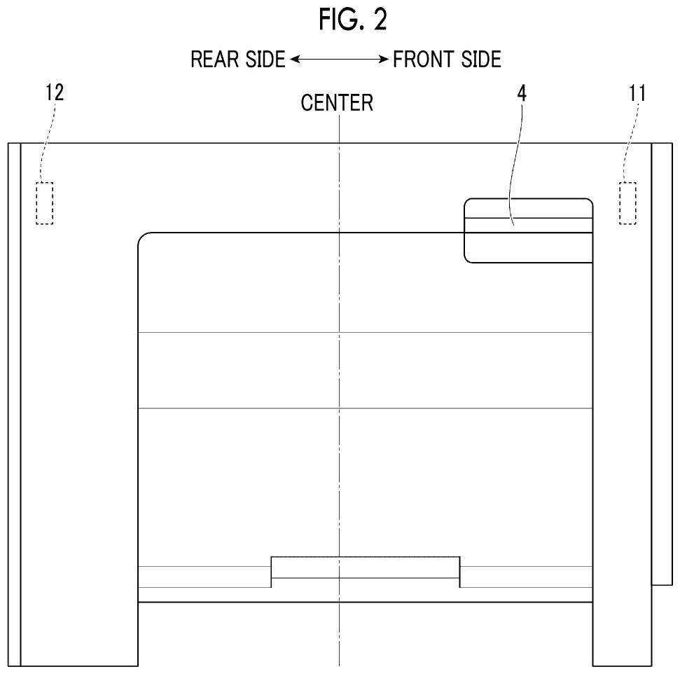

FIG. 2 is a view for description about a positional relationship between a handle 4, the first locking portion 11, and the second locking portion 12 and is a view showing the cover 3 as seen in the direction II shown in FIG. 1, which is a surface side.

The cover 3 includes the handle 4 serving as a handle that a user uses to perform an opening and closing operation. The handle 4 is provided closer to the front side than a center of the cover 3 is, which improves convenience for a user in a case where the user opens and closes the cover 3 from the front surface side, which is the front side. In a case where the handle 4 is provided at a position one-sided with respect to the center of the cover 3 as described above, the influence of an operation performed by a user on the cover 3 is not right-left symmetrical. That is, in the present exemplary embodiment, a front side of the cover 3 is likely to receive a force related to a closing operation from a user and a rear side of the cover 3 is less likely to receive the force related to the closing operation from the user in comparison with the front side.

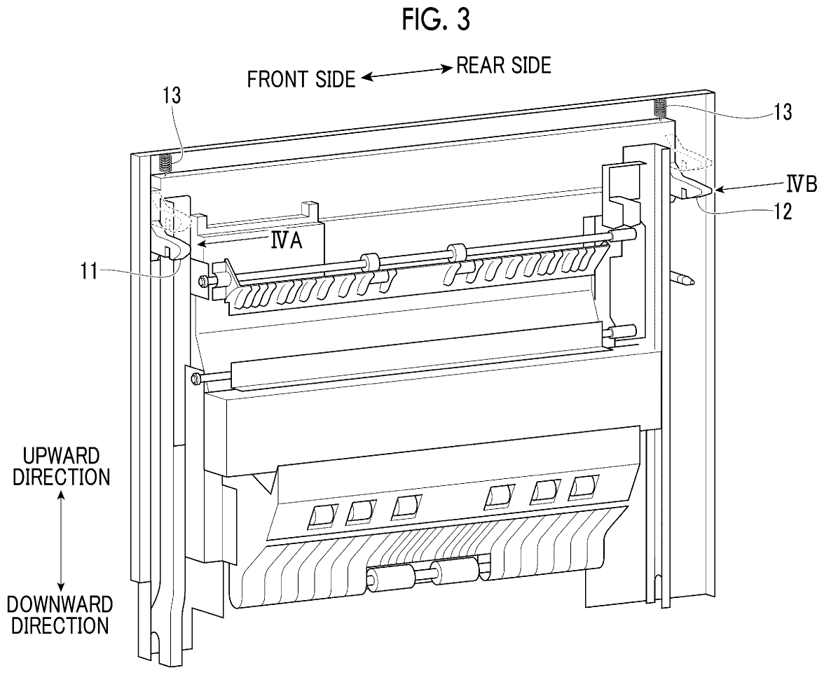

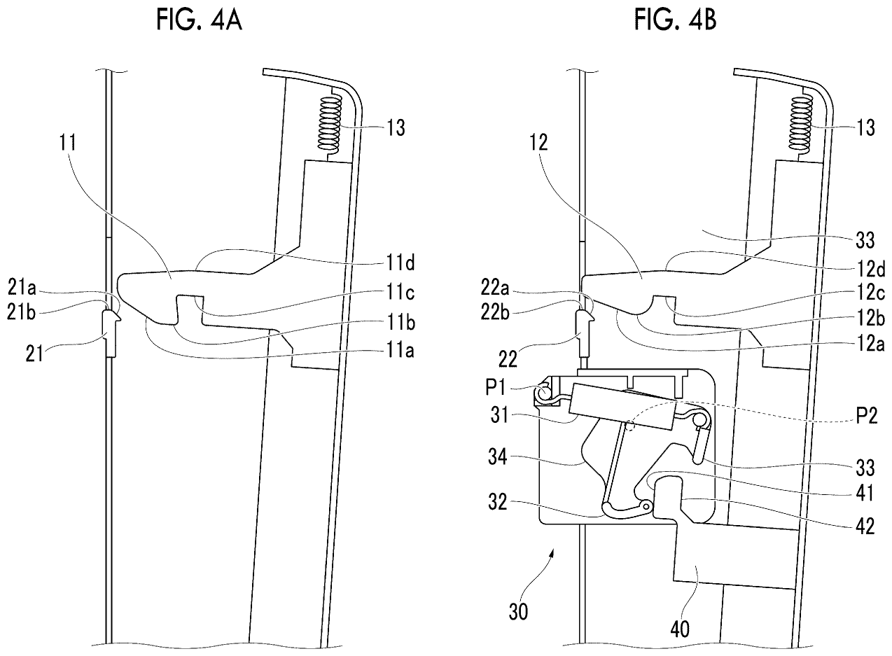

FIG. 3 is a view for description about the first locking portion 11 and the second locking portion 12 and is a view showing the cover 3 as seen in the direction III shown in FIG. 1. In the present exemplary embodiment, the handle 4, the first locking portion 11, and the second locking portion 12 are configured to be integrated with each other and are formed of, for example, resin by being integrally molded with each other. Accordingly, the first locking portion 11 and the second locking portion 12 can be operated in a vertical direction in conjunction with each other. Such an operation in the vertical direction is performed as a user lifts or lowers the handle 4. In addition, such an operation in the vertical direction is performed as an inclined surface 11a (which will be described later) of the first locking portion 11 slides along an inclined surface 21a (which will be described later) of the first locking target portion 21 or a bottom surface 11b (which will be described later) of the first locking portion 11 is separated from an upper surface 21b (which will be described later) of the first locking target portion 21 in response to a closing operation of the cover 3 as described in FIGS. 4A to 7B.

In addition, a force in the downward direction is applied to the first locking portion 11 and the second locking portion 12 due to the elastic force of the suspending spring 13. Therefore, in a case where a force in the upward direction is not applied to the first locking portion 11 and the second locking portion 12, the first locking portion 11 and the second locking portion 12 are fixed at closing positions, which are positions where the first locking portion 11 and the second locking portion 12 are locked together with the first locking target portion 21 and the second locking target portion 22. In the present exemplary embodiment, the first locking portion 11 and the second locking portion 12 are configured to be integrated with each other. However, the first locking portion 11 and the second locking portion 12 may not be configured to be integrated with each other.

FIGS. 4A and 4B are views for description about a configuration related to the housing 2 and the closing operation of the cover 3. FIG. 4A is a view showing the housing 2 and the cover 3 as seen in a direction IVA (refer to FIG. 3) which is a direction from the rear side to the front side, and is a view showing configurations of the housing 2 and the cover 3 on the front side. FIG. 4B is a view showing the housing 2 and the cover 3 as seen in a direction IVB (refer to FIG. 3) which is a direction from the rear side to the front side, and is a view showing a configuration of the cover 3 on the rear side.

As shown in FIG. 4A, the first locking portion 11 of the cover 3 includes the inclined surface 11a that slides along the inclined surface 21a after the inclined surface 11a comes into contact with the inclined surface 21a of the first locking target portion 21 in response to a closing operation of the cover 3. The inclined surface 11a is provided between a tip end of the first locking portion 11 that is on the housing 2 side and the bottom surface 11b. In addition, the first locking portion 11 includes the bottom surface 11b that slides along the upper surface 21b after the bottom surface 11b comes into contact with the upper surface 21b of the first locking target portion 21. The bottom surface 11b is provided at a lower portion of the first locking portion 11. Furthermore, the first locking portion 11 includes an insertion port 11c used to lock the first locking target portion 21. The insertion port 11c has a shape that is recessed upward from the lower portion of the first locking portion 11. In addition, the first locking portion 11 includes an upper surface 11d provided at an upper portion of the first locking portion 11.

In addition, as shown in FIG. 4A, the first locking target portion 21 of the housing 2 includes the inclined surface 21a slides after the inclined surface 21a comes into contact with the inclined surface 11a. The inclined surface 21a is provided between a tip end of the first locking target portion 21 that is on the cover 3 side and the upper surface 21b. In addition, the first locking target portion 21 includes the upper surface 21b slides after the upper surface 21b comes into contact with the bottom surface 11b of the first locking portion 11. The upper surface 21b is provided at an upper portion of the first locking target portion 21.

Next, as shown in FIG. 4B, the second locking portion 12 of the cover 3 includes an inclined surface 12a faces an inclined surface 22a of the second locking target portion 22 in response to a closing operation of the cover 3. The inclined surface 12a is provided between a tip end of the second locking portion 12 that is on the housing 2 side and a bottom surface 12b. In addition, the second locking portion 12 includes the bottom surface 12b that faces an upper surface 22b of the second locking target portion 22. The bottom surface 12b is provided at a lower portion of the second locking portion 12. Furthermore, the second locking portion 12 includes an insertion port 12c used to lock the second locking target portion 22. The insertion port 12c has a shape that is recessed upward from the lower portion of the second locking portion 12. In addition, the second locking portion 12 includes an upper surface 12d provided at an upper portion of the second locking portion 12.

In addition, as shown in FIG. 4B, the second locking target portion 22 of the housing 2 includes the inclined surface 22a that slides after the inclined surface 22a comes into contact with the inclined surface 12a of the second locking portion 12. The inclined surface 22a is provided between a tip end of the second locking target portion 22 that is on the cover 3 side and the upper surface 22b. In addition, the second locking target portion 22 includes the upper surface 22b that slides after the upper surface 22b comes into contact with the bottom surface 12b of the second locking portion 12. The upper surface 22b is provided at an upper portion of the second locking target portion 22.

Here, the inclined surface 11a of the first locking portion 11 and the inclined surface 12a of the second locking portion 12 are configured to have different shapes. In the present exemplary embodiment, the inclined surface 12a of the second locking portion 12 is configured to have a smaller slope than the slope of the inclined surface 11a of the first locking portion 11. That is, an angle with respect to the bottom surface 12b of the second locking portion 12 from the tip end of the second locking portion 12 that is on the housing 2 side is smaller than an angle with respect to the bottom surface 11b of the first locking portion 11 from the tip end of the first locking portion 11 that is on the housing 2 side.

Due to the difference in slope, an angle at which the inclined surface 11a of the first locking portion 11 and the inclined surface 21a of the first locking target portion 21 face each other and an angle at which the inclined surface 12a of the second locking portion 12 and the inclined surface 22a of the second locking target portion 22 face each other are different from each other. That is, the angle at which the inclined surface 11a of the first locking portion 11 and the inclined surface 21a of the first locking target portion 21 face each other is closer to a horizontal direction. In addition, the angle at which the inclined surface 12a of the second locking portion 12 and the inclined surface 22a of the second locking target portion 22 face each other is close to a perpendicular direction. That is, with a difference in angle at which the inclined surfaces face each other, the sliding resistance of the second locking portion 12 is smaller than the sliding resistance of the first locking portion 11. Otherwise, with a difference in angle at which the inclined surfaces face each other, a sliding resistance state where the first locking portion 11 has a sliding resistance but the second locking portion 12 has no sliding resistance is realized.

In addition, due to the difference in slope, a distance between the upper surface 12d of the second locking portion 12 and the bottom surface 12b of the second locking portion 12 is smaller than a distance between the upper surface 11d of the first locking portion 11 and the bottom surface 11b. Accordingly, a state where a sliding resistance is small or there is no sliding resistance is achieved in a case where the bottom surface 12b of the second locking portion 12 and the upper surface 22b of the second locking target portion 22 face each other in comparison with a case where the bottom surface 11b of the first locking portion 11 and the upper surface 21b of the first locking target portion 21 face each other.

In addition, as shown in FIG. 4B, the toggle mechanism 30 of the housing 2 includes a toggle spring 31 having an elastic force. The toggle spring 31 expands and contracts along an axis. The axis is a straight line passing through a center of the toggle spring 31 along a winding direction of the toggle spring 31. In addition, the toggle spring 31 is rotatable around a fulcrum P1. In addition, the toggle mechanism 30 includes a pressing target member 32 that comes into contact with a pressing portion 41 of the cover 3 in response to a closing operation of the cover 3. Furthermore, the toggle mechanism 30 includes a drawing member 33 that comes into contact with a drawing target portion 42 of the cover 3 in response to a closing operation of the cover 3. In addition, the toggle mechanism 30 includes a holding member 34 that holds the toggle spring 31, the pressing target member 32, and the drawing member 33. The holding member 34 is rotatable around a fulcrum P2, and the toggle spring 31, the pressing target member 32, and the drawing member 33 are operated in conjunction with each other by the holding member 34.

Furthermore, as shown in FIG. 4B, the toggle action member 40 of the cover 3 includes the pressing portion 41 that comes into contact with the pressing target member 32 in response to the closing operation of the cover 3 and the drawing target portion 42 that faces the drawing member 33 in response to the closing operation of the cover 3.

Next, action related to a case where the first locking portion 11 and the second locking portion 12 lock the first locking target portion 21 and the second locking target portion 22 in the closing operation of the cover 3 will be described with reference to FIGS. 4A to 7B. Note that the closing operation of the cover 3 is, for example, an operation in which the first locking portion 11 and the second locking portion 12 are brought close to the first locking target portion 21 and the second locking target portion 22 since a user performs a closing operation.

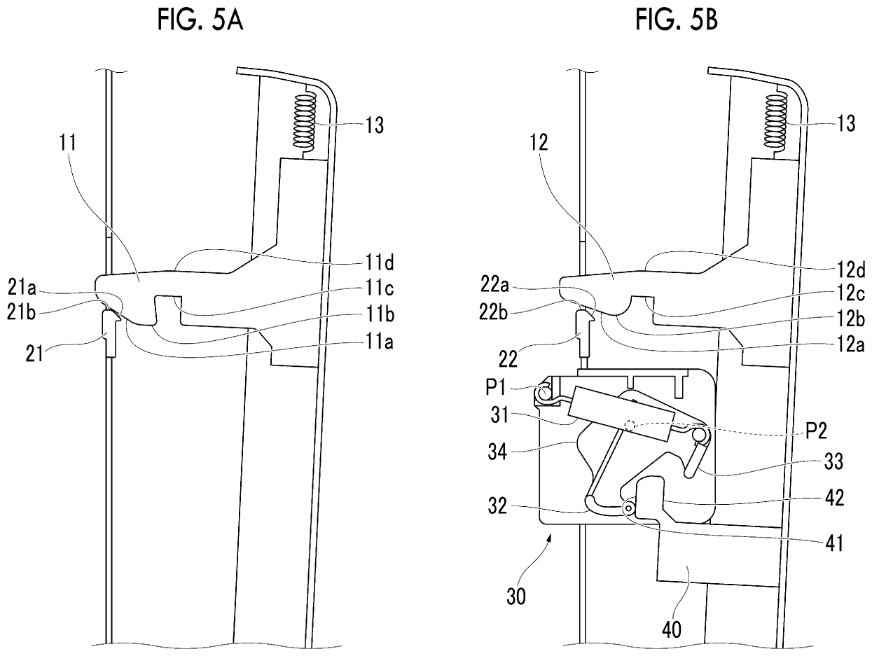

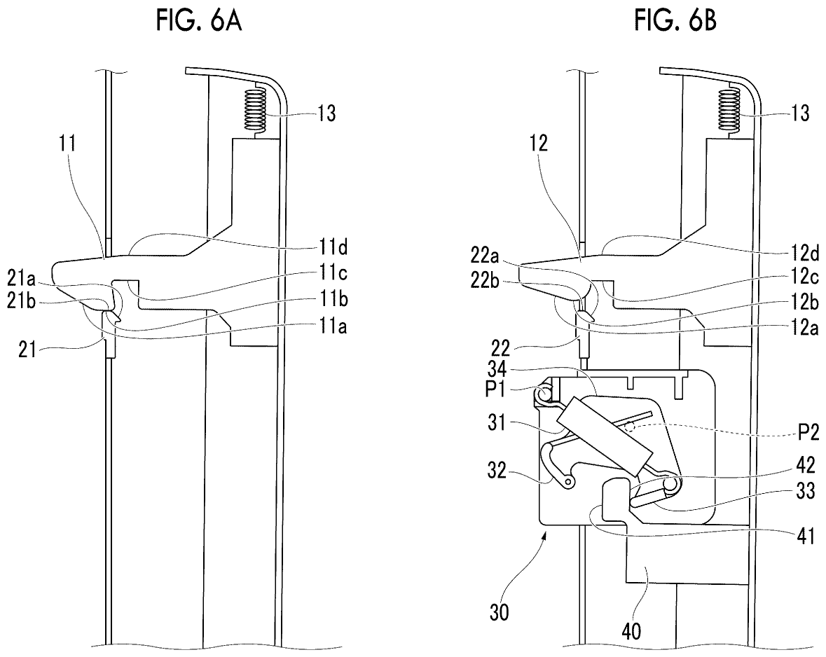

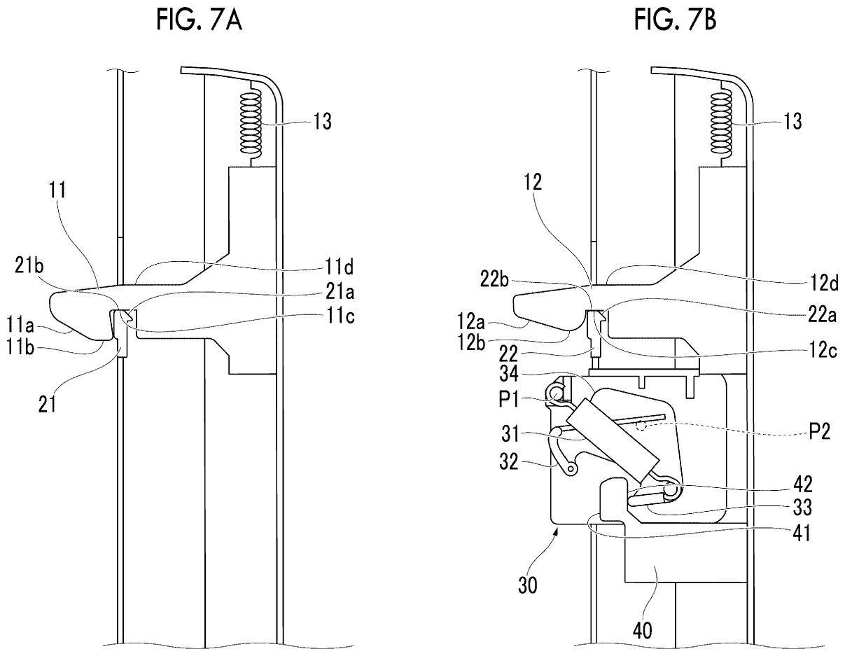

FIGS. 4A and 4B described above show a state before contact between the first locking portion 11 and the first locking target portion 21. In addition, FIGS. 5A and 5B are views showing a state where the inclined surface 11a of the first locking portion 11 is in contact with the inclined surface 21a of the first locking target portion 21 and FIGS. 6A and 6B are views showing a state where the bottom surface 11b of the first locking portion 11 is in contact with the upper surface 21b of the first locking target portion 21. Furthermore, FIGS. 7A and 7B are views showing a state where the first locking portion 11 and the second locking portion 12 are locked.

In a case where the closing operation of the cover 3 is performed in the state shown in FIGS. 4A and 4B, the inclined surface 11a of the first locking portion 11 and the inclined surface 21a of the first locking target portion 21 come into contact with each other as in the state shown in FIG. 5A on the front side of the cover 3. In a case where the closing operation is further performed after the contact, the inclined surface 11a of the first locking portion 11 slides along the inclined surface 21a of the first locking target portion 21. With the inclined surface 11a sliding along the inclined surface 21a, the first locking portion 11 is lifted along the inclined surface 11a of the first locking portion 11 in the state shown in FIG. 5A.

Meanwhile, in FIG. 5B showing the rear side of the cover 3, the inclined surface 12a of the second locking portion 12 and the inclined surface 22a of the second locking target portion 22 are not in contact with each other at the same time as in FIG. 5A. Then, in a case where the closing operation is further performed, the second locking portion 12 is lifted in the state shown in FIG. 5B in conjunction with the first locking portion 11 being lifted. While such a closing operation is being performed, the inclined surface 12a of the second locking portion 12 and the inclined surface 22a of the second locking target portion 22 do not come into contact with each other. Therefore, while such a closing operation is being performed, no sliding resistance is generated between the inclined surface 12a of the second locking portion 12 and the inclined surface 22a of the second locking target portion 22 although a sliding resistance is generated between the inclined surface 11a of the first locking portion 11 and the inclined surface 21a of the first locking target portion 21.

Next, in a case where the closing operation is further performed after the inclined surface 11a of the first locking portion 11 slides along the inclined surface 21a of the first locking target portion 21, the first locking portion 11 and the second locking portion 12 are further lifted. A load applied to the first locking portion 11 gradually increases as the first locking portion 11 is lifted. In this case, the inclined surface 12a of the second locking portion 12 does not come into contact with the inclined surface 22a of the second locking target portion 22.

Then, as in a state shown in FIG. 6A, the inclined surface 11a of the first locking portion 11 climbs over the inclined surface 21a of the first locking target portion 21 so that the bottom surface 11b of the first locking portion 11 comes into contact with the upper surface 21b of the first locking target portion 21. In a case where the closing operation is further performed, the bottom surface 11b of the first locking portion 11 slides along the upper surface 21b of the first locking target portion 21. A load applied to the first locking portion 11 in this case is only the resistance of a frictional force generated in a case where the bottom surface 11b of the first locking portion 11 slides along the upper surface 21b of the first locking target portion 21, and is smaller than a load applied in a case where the inclined surface 11a of the first locking portion 11 slides along the inclined surface 21a of the first locking target portion 21.

Meanwhile, in FIG. 6B showing the rear side of the cover 3, the bottom surface 12b of the second locking portion 12 and the upper surface 22b of the second locking target portion 22 are not in contact with each other at the same time as in FIG. 6A. Therefore, even in a case where the closing operation of the cover 3 is further performed, no sliding resistance is generated between the bottom surface 12b of the second locking portion 12 and the upper surface 22b of the second locking target portion 22 although a sliding resistance is generated between the bottom surface 11b of the first locking portion 11 and the upper surface 21b of the first locking target portion 21.

Next, in a case where the closing operation of the cover 3 is further performed in the state shown in FIG. 6A, the bottom surface 11b of the first locking portion 11 passes through the upper surface 21b of the first locking target portion 21 on the front side of the cover 3. Then, the bottom surface 11b is separated from the upper surface 21b so that the first locking portion 11 is lowered by a force generated by the suspending spring 13 and the first locking portion 11 enters a state shown in FIG. 7A.

In the state shown in FIG. 7A, the insertion port 11c of the first locking portion 11 comes into contact with the upper surface 21b of the first locking target portion 21 and a key-like shape of the first locking portion 11 is hooked on the first locking target portion 21. Accordingly, the first locking portion 11 locks the front side of the cover 3.

Meanwhile, in a case where the closing operation of the cover 3 is further performed in a state shown in FIG. 6B, the bottom surface 12b of the second locking portion 12 passes through the upper surface 22b of the second locking target portion 22 in conjunction with the operation of the first locking portion 11 on the rear side of the cover 3. In this case, the bottom surface 12b of the second locking portion 12 does not come into contact with the upper surface 22b of the second locking target portion 22. Then, the second locking portion 12 is lowered together with the first locking portion 11 being lowered in a state where the bottom surface 12b is not in contact with the upper surface 22b and the second locking portion 12 enters a state shown in FIG. 7B.

In the state shown in FIG. 7B, the insertion port 12c of the second locking portion 12 comes into contact with the upper surface 22b of the second locking target portion 22 and a key-like shape of the second locking portion 12 is hooked on the second locking target portion 22. Accordingly, the second locking portion 12 locks the rear side of the cover 3.

Note that a user can unlock the cover 3 by lifting the handle 4 (refer to FIG. 2) in the states shown in FIGS. 7A and 7B so that first locking portion 11 and the second locking portion 12 are lifted. In addition, an opening operation of the cover 3 is performed in a case where the user performs an opening operation in a state where the cover 3 is unlocked.

Next, a way in which the toggle mechanism 30 draws the cover 3 will be described with reference to FIGS. 4A to 7B.

The closing operation of the cover 3 is usually performed by a hand of a user from the front side of the image forming apparatus 1. As shown in FIG. 2, in a case where the cover 3 is pressed at a position closer to the front side than the center of the cover 3 is, the rear side of the cover 3 is less likely to receive a force related to a closing operation and, for example, positional deviation or the like is caused with the cover 3 twisted. In such a case, the second locking portion 12 cannot be hooked on the second locking target portion 22 of the housing 2 even in a case where the front side is pressed. Therefore, in the present exemplary embodiment, the toggle mechanism 30 is provided on the rear side to assist the closing operation of the cover 3.

First, in a state shown in FIG. 4B, the pressing portion 41 of the toggle action member 40 provided at the cover 3 is in contact with the pressing target member 32. In a case where the closing operation of the cover 3 is further performed thereafter, the pressing portion 41 presses the pressing target member 32 as shown in FIG. 5B and thus the axis of the toggle spring 31 rotates in a direction toward the fulcrum P2. Due to the rotation, the toggle spring 31 is pulled along the axis.

Thereafter, in a case where the closing operation is further performed in the state shown in FIG. 5B, the axis of the toggle spring 31 reaches the fulcrum P2 in a case where the inclined surface 11a of the first locking portion 11 climbs over the inclined surface 21a of the first locking target portion 21. In this case, the axis of the toggle spring 31 is aligned with the fulcrum P2 substantially linearly, and the toggle spring 31 is pulled maximally. In addition, in a case where the closing operation of the cover 3 is further performed with the toggle spring 31 being at such a position, the toggle spring 31 passes through the fulcrum P2 and the toggle spring 31 contracts so that the drawing member 33 starts to draw the drawing target portion 42 and the state shown in FIG. 6B is reached.

In the state shown in FIG. 6B, the drawing member 33 draws the drawing target portion 42 so that the rear side of the cover 3 is drawn. That is, the drawing of the drawing target portion 42 assists the closing operation on the rear side of the cover 3. Note that in a case where the closing operation is further performed in the state shown in FIG. 6B, the holding member 34 stops at a predetermined stoppage position and the cover 3 is completely drawn by the drawing member 33 so that the state shown in FIG. 7B is reached.

In the present exemplary embodiment, the second locking portion 12 does not come into contact with the second locking target portion 22 and no load is applied to the second locking portion 12 while the cover 3 is being drawn by the toggle mechanism 30. Therefore, a drawing force required for the second locking portion 12 to be hooked on the second locking target portion 22 is small in comparison with a case where a load is applied to the second locking portion 12.

Hereinabove, in the present exemplary embodiment, the first locking portion 11 on the front side of the cover 3 slides with respect to the first locking target portion 21 and is hooked on the first locking target portion 21 thereafter in response to the closing operation of the cover 3. Meanwhile, the second locking portion 12 on the rear side of the cover 3 is hooked on the second locking target portion 22 in response to the closing operation of the cover 3 without sliding with respect to the second locking target portion 22. That is, in the closing operation of the cover 3, the rear side of the cover 3 does not receive resistance attributable to friction. Accordingly, even on the rear side that is less likely to receive a force related to the closing operation from a user than the front side of the cover 3 is, the rear side of the cover 3 is easily locked.

In the present exemplary embodiment, a shape that does not cause a sliding resistance with respect to the inclined surface 22a of the second locking target portion 22 is adopted as the shape of the inclined surface 12a of the second locking portion 12. However, the shape of the inclined surface 12a may not be limited to such a shape. For example, a shape that causes a sliding resistance smaller than a sliding resistance caused in a case where the first locking portion 11 slides with respect to the first locking target portion 21 may be adopted as the shape of the inclined surface 12a of the second locking portion 12. In addition, the materials of the inclined surface 11a of the first locking portion 11 and the inclined surface 12a of the second locking portion 12 may be different from each other. For example, as the material of the inclined surface 12a of the second locking portion 12, a material that results in the friction coefficient of the first locking portion 11 being smaller than the friction coefficient of the second locking portion 12 may be adopted. Furthermore, the first locking target portion 21 and the second locking target portion 22 may be made different from each other. For example, the inclined surface 12a of the second locking portion 12 may be changed to a roller or the like so that the sliding resistance of the second locking portion 12 with respect to the second locking target portion 22 is smaller than the sliding resistance of the first locking portion 11 with respect to the first locking target portion 21.

### Supplementary Note

(((1)))

An image forming apparatus comprising:
an apparatus body in which image formation is performed;
an opening and closing member that is openable and closable with respect to the apparatus body;
a first locking portion that is provided on one side of the opening and closing member and that locks the opening and closing member while sliding with respect to a locking target portion on one side of an apparatus body side; and
a second locking portion that is provided on the other side of the opening and closing member and that locks the opening and closing member via a locking target portion on the other side of the apparatus body side in a state where there is a sliding resistance smaller than a sliding resistance generated in a case where the first locking portion slides with respect to the locking target portion on the one side or a state where there is no sliding resistance.
   (((2)))

The image forming apparatus according to (((1))),
wherein the first locking portion includes an inclined surface that slides with respect to the locking target portion on the one side after the inclined surface comes into contact with the locking target portion on the one side in response to a closing operation of the opening and closing member, is lifted as the inclined surface slides with respect to the locking target portion on the one side, and is locked as the inclined surface climbs over the locking target portion on the one side, and
the second locking portion operates and is locked with respect to the locking target portion on the other side as the first locking portion operates.
   (((3)))

The image forming apparatus according to (((2))),
wherein the second locking portion does not come into contact with the locking target portion on the other side in a case where the first locking portion comes into contact with the locking target portion on the one side.
   (((4)))

The image forming apparatus according to (((3))),
wherein the first locking portion and the second locking portion are configured to be integrated with each other, and
an assistance mechanism that assists the closing operation of the opening and closing member is provided on the other side of the apparatus body side.
   (((5)))

The image forming apparatus according to (((1))),
wherein the first locking portion includes an inclined surface that slides with respect to the locking target portion on the one side after the inclined surface comes into contact with the locking target portion on the one side in response to a closing operation of the opening and closing member, operates as the inclined surface slides with respect to the locking target portion on the one side, and is locked as the inclined surface climbs over the locking target portion on the one side, and
the second locking portion includes an inclined surface that slides with respect to the locking target portion on the other side after the inclined surface comes into contact with the locking target portion on the other side in response to the closing operation of the opening and closing member and of which a shape or a material is different from the first locking portion, operates as the inclined surface slides with respect to the locking target portion on the other side, and is locked as the inclined surface climbs over the locking target portion on the other side.
   (((6)))

The image forming apparatus according to (((5))),
wherein a slope of the inclined surface of the second locking portion is smaller than a slope of the inclined surface of the first locking portion.
   (((7)))

The image forming apparatus according to (((5))),
wherein a friction coefficient of the inclined surface of the second locking portion is lower than a friction coefficient of the inclined surface of the first locking portion.
   (((8)))

The image forming apparatus according to (((1))),
wherein the locking target portion on the other side is made different from the locking target portion on the one side such that a sliding resistance generated in a case where the second locking portion slides with respect to the locking target portion on the other side is made smaller than a sliding resistance generated in a case where the first locking portion slides with respect to the locking target portion on the one side.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an apparatus body in which image formation is performed;
an opening and closing member that is openable and closable with respect to the apparatus body;
a first locking portion that is provided on one side of the opening and closing member and that locks the opening and closing member while sliding with respect to a locking target portion on one side of an apparatus body side; and
a second locking portion that is provided on the other side of the opening and closing member and that locks the opening and closing member via a locking target portion on the other side of the apparatus body side in a state where there is a sliding resistance smaller than a sliding resistance generated in a case where the first locking portion slides with respect to the locking target portion on the one side or a state where there is no sliding resistance.

2. The image forming apparatus according to claim 1,
wherein the first locking portion includes an inclined surface that slides with respect to the locking target portion on the one side after the inclined surface comes into contact with the locking target portion on the one side in response to a closing operation of the opening and closing member, is lifted as the inclined surface slides with respect to the locking target portion on the one side, and is locked as the inclined surface climbs over the locking target portion on the one side, and
the second locking portion operates and is locked with respect to the locking target portion on the other side as the first locking portion operates.

3. The image forming apparatus according to claim 2,
wherein the second locking portion does not come into contact with the locking target portion on the other side in a case where the first locking portion comes into contact with the locking target portion on the one side.

4. The image forming apparatus according to claim 3,
wherein the first locking portion and the second locking portion are configured to be integrated with each other, and
an assistance mechanism that assists the closing operation of the opening and closing member is provided on the other side of the apparatus body side.

5. The image forming apparatus according to claim 1,
wherein the first locking portion includes an inclined surface that slides with respect to the locking target portion on the one side after the inclined surface comes into contact with the locking target portion on the one side in response to a closing operation of the opening and closing member, operates as the inclined surface slides with respect to the locking target portion on the one side, and is locked as the inclined surface climbs over the locking target portion on the one side, and
the second locking portion includes an inclined surface that slides with respect to the locking target portion on the other side after the inclined surface comes into contact with the locking target portion on the other side in response to the closing operation of the opening and closing member and of which a shape or a material is different from the first locking portion, operates as the inclined surface slides with respect to the locking target portion on the other side, and is locked as the inclined surface climbs over the locking target portion on the other side.

6. The image forming apparatus according to claim 5,
wherein a slope of the inclined surface of the second locking portion is smaller than a slope of the inclined surface of the first locking portion.

7. The image forming apparatus according to claim 5,
wherein a friction coefficient of the inclined surface of the second locking portion is lower than a friction coefficient of the inclined surface of the first locking portion.

8. The image forming apparatus according to claim 1,
wherein the locking target portion on the other side is made different from the locking target portion on the one side such that a sliding resistance generated in a case where the second locking portion slides with respect to the locking target portion on the other side is made smaller than a sliding resistance generated in a case where the first locking portion slides with respect to the locking target portion on the one side.
